(19) United States
(12) Patent Application Publication
(10) Pub. No.: US 2005/0010442 A1
(43) Pub. Date: Jan. 13, 2005

(54) Health information database creation and secure access system and method

(76) Inventor: James F. Kragh, Winter Park, FL (US)

Correspondence Address: ALLEN, DYER, DOPPELT, MILBRATH & GILCHRIST, PA, P.O. BOX 3791, ORLANDO, FL, 32802-3791, US

(21) Appl. No.: 10/841,417

(22) Filed: May 7, 2004

Related U.S. Application Data
(60) Provisional application No. 60/468,838, filed on May 8, 2003.

(51) Int. Cl. G06F 17/60

(52) U.S. Cl. 705/2

(57) ABSTRACT

A healthcare data management system includes a central processor and a database accessible by the processor that contains an electronic personal health journal. The journal includes a plurality of fields of information relating to a patient, including health status. A software program installed on the processor is adapted to establish secure communication between a user and the processor to interact with an information field of the journal subject to a predetermined permission level, which is established on the basis of a relationship between the user and the patient and on the basis of user entity and is determinative of the information fields to which the user is permitted access and of the information fields that are amendable by the user. Methods are provided for accessing and maintaining health data, increasing patient compliance, and decreasing duplication of services, healthcare costs, and iatrogenic pharmaceutical interactions.

### CROSS-REFERENCE TO RELATED APPLICATION

This application claims priority to provisional application Ser. No. 60/468,838, filed May 8, 2003, entitled “Health Information Database Creation and Access System and Method.”

### BACKGROUND OF THE INVENTION

1. Field of the Invention

The present invention relates to healthcare database systems and methods, and, more particularly, to systems and methods for housing healthcare information, improving patient compliance, and providing secure, role-based access to healthcare databases and protected health information.

2. Description of Related Art

Healthcare information databases are known in the art for keeping an insurance plan member's health-related activity and demographic data. Typically such data are housed by the insurance company so as to be accessible only by an authorized user, such as an employee of the insurance company. If the member leaves that insurance company, his or her records are generally not transferrable to the next insurance company.

Additionally, if the “plan member” comprises a family, at some point the definition of that family is likely to change, through, for example, a child's reaching maturity, death, or divorce. With such a change, a part of the family's data may need to be transferred to another plan.

Another problem relates to uninsured patients, for whom no database entries may exist. Caring for such patients, especially those with chronic conditions such as diabetes, asthma, heart disease, obesity, depression, and substance abuse, consume a large portion of a hospital's budget, as well as other governmental funds, such as those of a county Public Health department, Medicare, and Medicaid. Costs associated with these and other chronic diseases consume 60-70% of the healthcare dollar.

Often uninsured patients use hospital emergency rooms as their source of primary care, leading to often unnecessary and/or preventible emergency room visits. No system is currently in place to assist such patients in managing their diseases; thus the current system is reactive, not proactive.

Further, since no database entries may exist for such uninsured patients, their personal health data are likely not to be available for review by qualified caregivers for whom such knowledge could significantly improve the care provided.

Access to records has also been problematic, with privacy issues being paramount. One may desire access to one's own records to view or update their personal health record electronically with medical data, and need to prove identification, such as voice recognition, personal identification number, a token, or a biometric, for example. In other situations, such as in emergencies, medical personnel may need access to some or all of a member's data when obtaining conscious permission of the member is not possible.

The Health Information Protection and Administration Act of 1996 (HIPAA) was enacted to streamline the exchange of information in the healthcare industry and to reduce general administrative tasks while maintaining patient privacy. The three major tenets of this Act include (1) standard X.12 EDI transactions be created and maintained for the healthcare accounting part of the industry; (2) security to protect and electronically share all patient medical history information; and (3) unique identifiers be created and used for all patients, providers, payees, and employees in the healthcare industry for the purpose of providing authorization and accessing personal health data. Providers must have an electronic tracking mechanism in place to document disclosure of individually identified health information, and individuals must give written authorization and/or consent if data are to be shared. As the definition of a “health record” has become increasingly complex, no longer limited to a single physical folder in a doctor's or hospital's filing system, a system is required for coordinating healthcare efforts among many facilities and platforms, and for providing patient access.

Additional problems in the healthcare industry are fraud and waste that can occur if a patient visits more than one facility for the same complaint.

Therefore, there is a need for a secure infrastructure and patient-centric system that provides electronic healthcare data that are encrypted, can be authenticated, possess a digital signature, and include access and role-based control on a secure basis.

### SUMMARY OF THE INVENTION

The system and methods of the present invention integrate secure network management features into an enterprise-wide business application to reduce medical costs while granting individuals access to their health information and to health planning tools to provide improved health and healthcare. The invention reduces duplication, waste, fraud, and abuse in Public Health, and provides tools and technology for secure information sharing among disparate systems to improve the quality and cost-effectiveness of care through information technology and, in some cases, outreach. The system includes a standards-based common communication platform with secure links to an integrated, virtual private network, for hosting a web-based personal health journal for patients. Personal health data can be updated remotely, and clinical information can be shared with authorized healthcare providers and case/care managers based upon consent and authorization. The system complies with HIPAA, having privacy and security provisions built in.

At the heart of the system is a personal health journal, which is populated by the individual and caregivers, and includes pertinent patient data including protected health data. The personal health journal is not necessarily intended to be comprehensive, but rather to comprise a “snapshot” of the patient's current medical condition for assisting in delivering immediate care when needed.

Also provided are user-friendly technology and disease-specific educational information that is accessible by the patient. The patient is encouraged to actively participate in managing his/her own health with assistance from care managers and, in one embodiment, “buddies,” coupled with incentives provided in one or more of a plurality of methods.

A particular benefit of the system is that security is at the device level, that is, the patient and care givers treating the patient operate with the use of an electronic certificate that is carried with the person, and does not reside on a network at the system level.

The system and method are designed to increase compliance and reduce healthcare costs, to improve patient care and safety, reduce clinical and clerical errors, and to provide authorized caregivers with timely access to a patient's clinical information in order to increase compliance and reduce duplication of services.

In addition, a funding model is presented whereby the system functions as a self-sustaining organization to benefit the healthcare industry and public health.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is a system schematic showing an overview of the system modules.

FIG. 2 is a schematic diagram of an exemplary embodiment of system information flow.

FIG. 3 illustrates exemplary screen tabs for a personal health journal.

FIG. 4 is a flowchart of a first embodiment of a method for improving patient compliance in disease management using electronic communication.

FIG. 5 is a flowchart of a second embodiment of a method for improving patient compliance in disease management using direct contact with a case manager.

FIG. 6 is a flowchart of a method for decreasing duplication of services.

FIG. 7 is a flowchart of a method for reducing a likelihood of adverse drug interactions.

FIG. 8 is a schematic diagram of the funding and services model of the present invention.

### DETAILED DESCRIPTION OF THE PREFERRED EMBODIMENTS

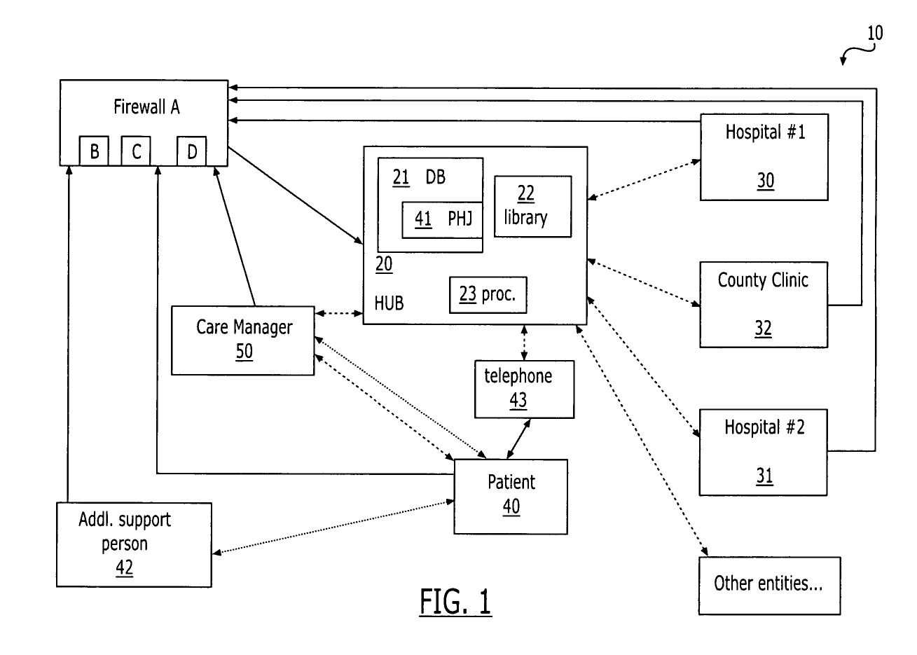

A description of the preferred embodiments of the present invention will now be presented with reference to FIGS. 1-8.

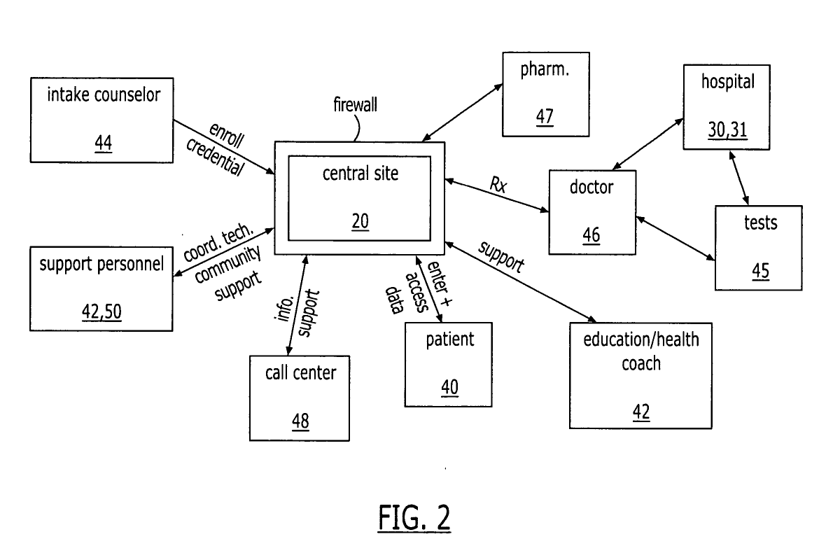

The system 10, as schematically illustrated in FIGS. 1 and 2, comprises a central site 20 housing a database 21 and a library 22 of health information geared for consumers. A processor 23 runs database creation and maintenance applications, and is adapted for network communication, such as over the Internet or other means of signal transmission. The system 10 permits data sharing, for example, among multiple platforms on such networks as wireless wide-area networks and local area networks. Database access (HUB) is gathered through secure Firewall A, which includes a role-based access directory. The broken line signifies bidirectional communication via a firewall. The dotted line signifies bidirectional communication via personal contact.

A patient 40 initially meets with an intake counselor 44 to enroll in the program and to provide biometric identifier(s) for subsequent access approval and to initially populate a personal health journal (PHJ) 41. Once enrolled, a patient can access his/her PHJ 41 by providing, for example, biometric data B, such as fingerprint, token, voice print, or eye print, such as via a portable electronic memory device, for example, a “smart card,” “smart token,” or USB dongle, via Firewall A to access the HUB in order to update his/her account and/or retrieve data from the PHJ 41.

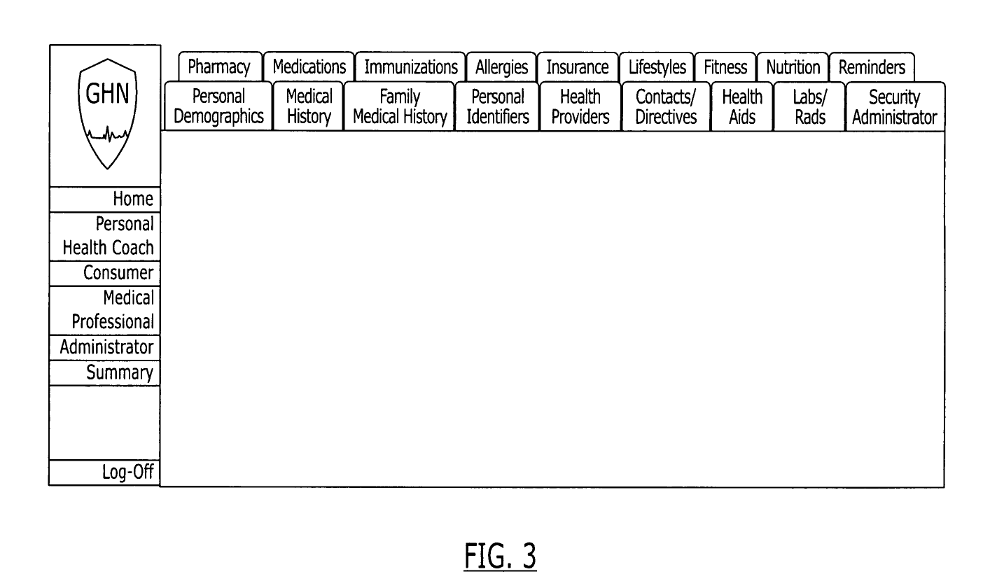

Included in the PHJ 41 (see, for example, an exemplary screen showing tabs in FIG. 3) are such data as demographic information, family and personal health history, allergies, medications, health activities, caregiver identification, links to laboratory results, and disease-specific information such as diagnoses, procedures, and care plans. An exemplary set of screen tabs is given in FIG. 3 for access to various sets of data. A scanning function permits the inclusion of images of documents in the PHJ 41, such as signed authorizations, consent forms, do not resuscitate forms, organ donor forms, and laboratory test results, although these are not intended as limitations. Accumulated health indicator tracking data are also stored in the PHJ 41, as entered by the patient and caregivers.

A care manager 50, which here is intended to include a licensed care giver such as a doctor, nurse, technician, etc., can only communicate electronically with a patient 40 if proper identification is made, such as biometric identification. Once approved for access, limited patient information is available, based upon the consent and/or authorization of the patient, and data on the patient 40 may be updated. The patient 40 controls which data can be viewed, and can change their personal health data. However, they are not permitted to change any data that have been entered by the care manager 50.

The patient also has access to a call center 48 for assisting in compliance, reminders for physician visits, and disease-specific education.

A licensed caregiver (such as a doctor, nurse, pharmacist, or laboratory technician) at sites 30-32, a pharmacy 47, or testing facility 45 can only review and document or update a patient file if registered within the system 10 and in possession of a security certificate (e.g., PKI) issued through a “trusted authority” C. In a preferred embodiment, all digital certificates are issued to the end user by a certification authority and the registering authority. These certificates are “roaming certificates,” meaning that a certificate holder does not have to be in a predetermined location in order to access data. The certificates are also nonrepudiatable. Upon receiving a certificate, a private digital key D is issued that will provide identification with unique roles within the medical environment and permit access to the HUB for the purpose of updating, signing, and documenting a patient's record.

Another feature of the system 10 is the creation of an electronically accessible and visible audit trail, providing data on the identity of anyone who has accessed a patient's record, what action, if any, was performed, and the date of access for preventing, for example, duplication of services and potential adverse drug interactions.

An individual electronic ID is assigned to the patient 40 for portability and security and to a specific location having specific functions. Such locations may include, but are not intended to be limited to, a hospital 30,31, a clinic 32, a physician's office, laboratory, home care center, pharmacy, prison, ambulance, or not-for-profit center.

The secure firewall A provides private and authenticated access into the HUB and, based upon one's unique role, allows information to be shared.

Medical facilities having processors such as a first 30 and a second 31 hospital and a county clinic or laboratory 32 are adapted for data flow with the central site 20, such as over the Internet 24.

A patient 40, for example, an uninsured patient, can, at any of the medical facilities 30-32 establish an electronic personal healthcare journal 41 with appropriate documentation and authentication. The journal 41 is accessible only by the patient unless privileges are granted to another party, and is housed in the central site's database 21. In addition to entering data on the patient's current health and past health history, such information as organ donor status may also be included. A guardian may also be granted permission to create a journal 41 for the person in his/her care, such as a parent for a child.

The patient 40 also has access to informational presentations housed in the central site's library 22. Such presentations may include educational information and information on disease management, for example, although these are not intended as limitations.

A care manager 50 assigned to assist the patient 40 can meet with the patient 40 and access limited information at the central site's database 21, to which the care manager 50 will have been given privileges, either partial or limited, for and by the patient 40.

In addition, a relative, associate, or motivational partner (“buddy”) 42 of the patient 40 may also be given access, which may be limited, to the PHJ with explicit permission from the patient 40. Such access may also be limited to particular data fields as desired and designated by the patient 40. Such data fields may include, at a relatively low level, an appointment reminder for a doctor visit. A volunteer “buddy” may be assigned, for example, by a not-for-profit or faith-based organization to provide support via telephone calls, emails, and personal visits. This volunteer serves to encourage patients to self-manage their disease to as great an extent as possible, and to educate the patient 40 in areas such as nutrition, exercise, testing (such as blood glucose, blood pressure, and weight monitoring), and follow-up physical examinations and testing.

Another particular benefit of the present invention is the portability of healthcare data between facilities and, if present, insurance companies, as physical records are no longer required to be transferred. Rather, the access permissions are changed to reflect the patient's current relationship(s). Thus the same credentials can be used for all systems and over all platforms without interface problems, so that, for example, Medicare and Medicaid and individual insurance companies can be participants.

The embodiments of the methods of the present invention are directed to a method for accessing healthcare data, a method for increasing patient compliance in disease management, a method for reducing healthcare costs for all patients, and a method for reducing duplication of services, which particularly impacts the care of uninsured patients. Here the phrase “disease management” is intended to encompass any ongoing condition that has or may have an impact on the patient's health. For example, obesity is intended to be subsumed under this method. In the case of a patient 40 with a chronic disease, for example, diabetes, careful daily monitoring and medication compliance are extremely important.

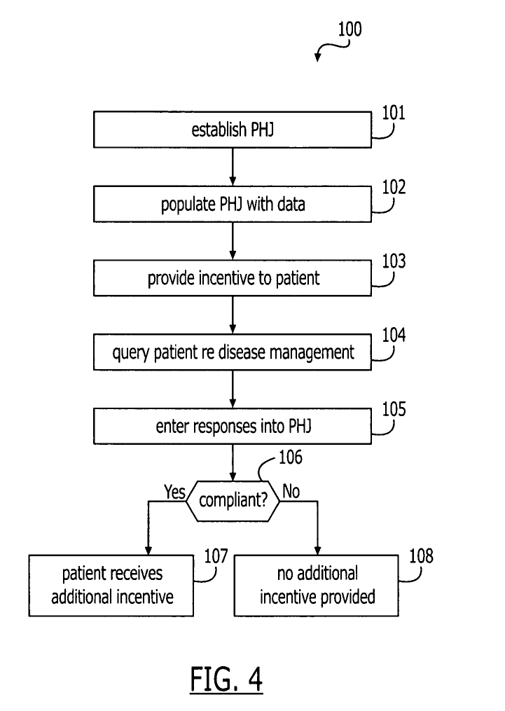

These methods include the steps of, at some point during a treatment cycle, setting up a personal health journal 41 for the patient 40 (FIG. 4, block 101). The journal 41 is populated with a health history record (block 102) that is updated at least during each visit to a medical facility 30-32.

One aspect of the invention includes a method 100 for improving compliance in disease management (FIG. 4), which also serves to lower healthcare costs. In an exemplary embodiment of this aspect, which is not intended as a limitation, an incentive is provided for compliance. Here a portable telephone 43 is given to the patient (block 103). The system 10 automatically telephones the patient 40 at predetermined intervals and queries the patient 40 as to disease management (“Did you take your insulin today?”; “What was your blood sugar reading?”; “How many calories did you consume yesterday?”; “What was your weight today?”; “How do you feel?”) (block 104). Voice or other biometric recognition is used to ensure that it is the patient him/herself who is answering. Data corresponding to the patient's answers are entered into the PHJ 41 (block 105), and compliance or noncompliance is automatically recorded (block 106). An additional incentive, such as increased time limits on the telephone 43, is provided for compliance (block 107). Noncompliant patients do not receive the incentive (block 108). Both the incentives and the telephonic reminders increase compliance. Further, having such a digital record updated on a frequent basis without taking the time of a medical facility 30-32 greatly improves the healthcare that medical personnel can offer when the patient 41 does visit, since the medical personnel can access the patient's PHJ 41 and view the history, and since the patient's memory is not being relied on to report compliance.

Other types of incentives can also be contemplated, including, but not intended to be limited to, food coupons, prescription coupons and testing supplies, transportation tokens, movie passes, phone cards, and limited memberships to an exercise facility.

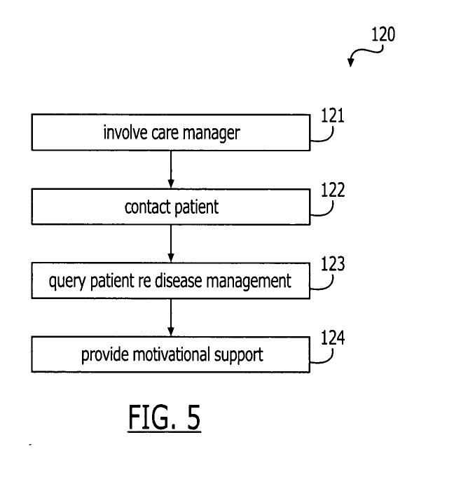

In another aspect 120 of the present invention (FIG. 5), the function of the care manager 50 is proactive (block 121). The care manager 50 can function to assist the patient 40 in keeping his/her care up to date (block 122) and by asking similar questions to those above (block 123), and can also provide additional motivational support (block 124), as with the “buddy” volunteer described above. This can help avoid crises and trips to the hospital. In the embodiment of FIG. 4, the patient 40 may be given a device such as a bidirectional personal data assistant (PDA), cell phone, or other electronic/digital device for reporting daily activities to the care manager 50. Thus the care manager 50 can log the patient's data and provide a personal support system for the patient 40.

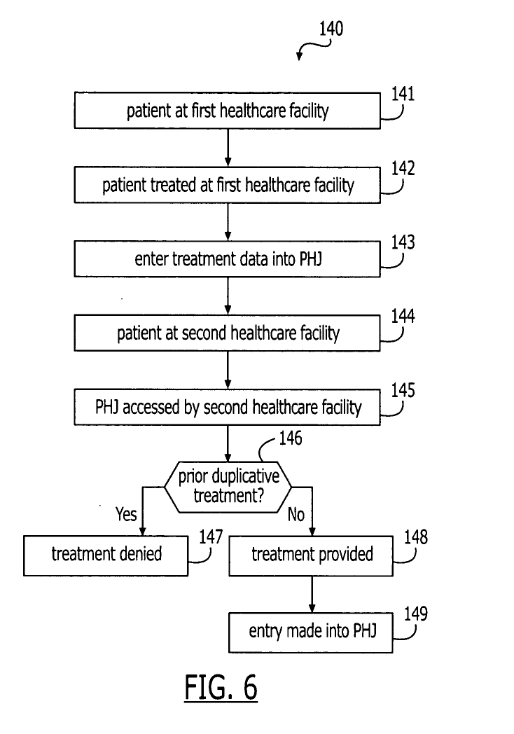

A method 140 for achieving a substantial cost savings in treating patients, including uninsured patients, is also addressed by the present invention. In this embodiment (FIG. 6), the patient 40 appears for treatment at the first hospital 30 (block 141), is treated (block 142), and data are entered into the patient's PHJ 41 reflecting the date and type of treatment (block 143). The patient 40 then appears at the second hospital 31 in an attempt to obtain the same treatment (block 144). Personnel at the second hospital 31 access the patient's PHJ 41 (block 145) with permission from the patient 40, and check for previous treatment(s). If such a visit resulted in a treatment for the same condition for which the patient 40 is seeking help at the second hospital 31 within a predetermined time limit (block 146), treatment is denied (block 147), thus saving hospital resources. If not, treatment is provided (block 148), and a record is entered into the PHJ 41 (block 149).

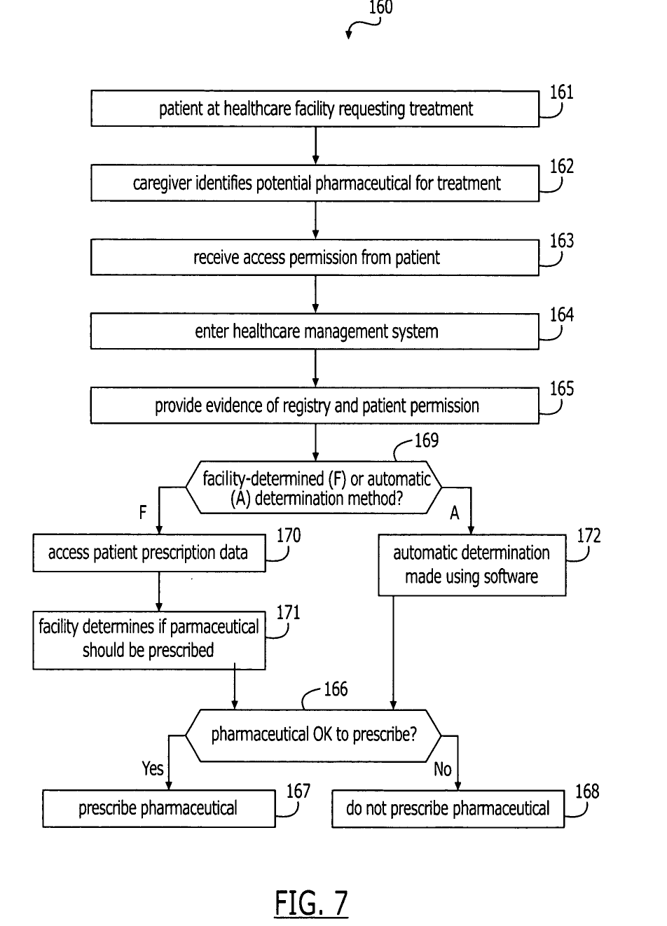

The present invention also addresses the problem of potentially harmful drug interactions (FIG. 7). Such adverse interactions can occur, for example, if different drugs are prescribed by different doctors who under the current state of the art would not have access to a list of medications being prescribed elsewhere for the patient 40. The problem is addressed by a method 160 that comprises the steps of receiving at a healthcare facility 30 a request from a patient 40 for treatment for an ailment (block 161) and identifying a potential pharmaceutical with which to treat the ailment (block 162).

The facility 30 then receives permission from the patient 40 for secure access to a portion of an electronic healthcare record 41 including patient prescription data (block 163) and electronically enters a secure healthcare management system 10 that comprises the database 21 housing prescription data on the patient 40 (block 164).

The facility 30 and the patient 40 must provide electronic certification to the system 10 of a registry of the facility 30 with the system 10 and of the received permission (block 165). If the identified pharmaceutical and the patient prescription data meet predetermined criteria (block 166), the identified pharmaceutical is prescribed to the patient 40 (block 167). Otherwise, the identified pharmaceutical is not prescribed (block 168).

Two exemplary embodiments of this method 160 may be contemplated (block 169). In one embodiment, following the electronic certification providing step (block 165), the patient prescription data is accessed (block 170) and a determination at the healthcare facility 30 is made of an advisability of prescribing the identified pharmaceutical (block 171) based upon any other currently prescribed pharmaceutical(s).

In an alternate embodiment, the healthcare management system 10 includes software for making a determination of a potential for an adverse interaction between the identified pharmaceutical and any currently prescribed pharmaceutical in the patient prescription data (block 172).

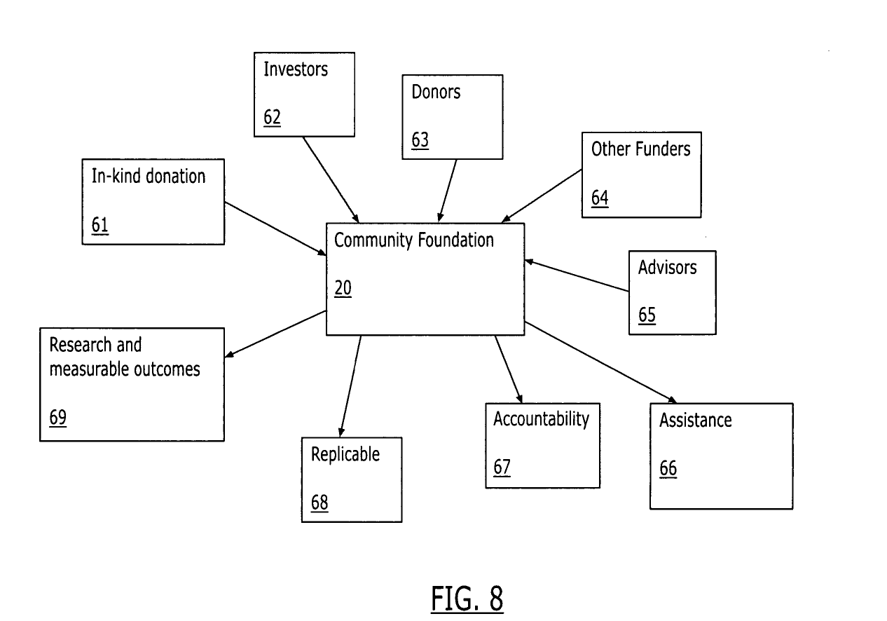

A method 60 of funding such a system 10 illustrated in FIG. 8, which is believed to represent a significant improvement in achieving better healthcare for the both the insured and the uninsured segments of the population, as well as lowering costs for providing such healthcare. This embodiment of the method 60 of the present invention relies on community-based and/or faith-based initiatives to succeed, although this is not intended as a limitation.

At the center of FIG. 8 is the community foundation, depicted as the central site 20. Fund and information flow is illustrated by arrows leading into and out of the foundation 20. Those providing funds include, but are not intended to be limited to, in-kind donation partners 61 such as local corporations; investors 62 such as hospitals, county or city governments; donors 63 such as foundations, individuals, philanthropists, corporations, faith-based groups, and pharmaceutical corporations; and other funders such as national charitable organizations 64. Other, nonmonetary, input may come in the form of advisors 65 such as investors, universities, city or county government, faith-based organizations, doctors, nurses, and care-givers.

Services provided by the foundation 20 include providing assistance to other entities, such as, but not intended to be limited to, not-for-profit entities, who care for the uninsured with chronic diseases and/or disabilities. Also provided are accountability, that is, fiduciary distribution of funds 67, a replicable model for other communities to adopt and research, a community-based Advisory Board, and measurable outcomes 69. A double-blinded database of outcomes 69 can be used to formulate effective case-management techniques, guidelines for success in serving the uninsured, patient satisfaction surveys, fewer emergency room visits, increased patient compliance, nonprofit efficiency, and community reporting. Research may also be utilized by universities to further improve the knowledge base for caregiving.

The foundation 20 also functions to coordinate the volunteer “buddies” with the patients 40 and to assist in patient enrollment functions.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the system and methods illustrated and described herein are by way of example, and the scope of the invention is not limited to the exact details disclosed herein.

1. A healthcare data management system comprising:
a central processor;
a database accessible by the processor, the database containing an electronic personal health journal, the journal comprising a plurality of fields of information relating to a patient, including health status;
a software program installed on the processor adapted to establish secure communication between a user and the central processor to interact with an information field of the journal subject to a predetermined permission level, the permission level established on the basis of a relationship between the user and the patient and on the basis of user entity and is determinative of the information fields to which the user is permitted access and of the information fields that are amendable by the user.

2. The system recited in claim 1, wherein the software program is adapted to interface with a remote processor for collecting certification data on the user including user entity and identification data.

3. The system recited in claim 1, wherein the user is different from the patient, and the user entity comprises a role of the user.

4. The system recited in claim 3, wherein the user role is selected from a group consisting of a licensed medical practitioner, a guardian, a relative, and a designated motivational partner.

5. The system recited in claim 1, wherein the software program includes means for verifying a user identity based upon at least one of biometric data and electronic memory device.

6. The system recited in claim 1, wherein the user comprises the patient, and the information fields amendable by the user include personal health data and the information fields restricted for emendation by the user include health record data entered by a caregiver.

7. The system recited in claim 1, wherein the journal comprises an information field containing a digitized document having a user signature thereon.

8. The system recited in claim 1, wherein the database further comprises user-accessible public information including educational disease-specific information.

9. The system recited in claim 1, wherein the journal comprises data including patient prescription history, patient laboratory test results, and patient treatment history.

10. The system recited in claim 1, wherein the user comprises a motivational partner and the informational fields accessible by the motivational partner include patient self-management data.

11. A method for accessing and amending patient healthcare data comprising the steps of:
receiving a request from a user to electronically access a healthcare data management database for data on a patient;
requesting the user to provide an electronic, secure identification;
verifying an entity of the user and a relationship between the user and the patient; and
if the user has a valid certification and the relationship between the user and the patient has been established in the database:
accessing in the database a data filter to be applied to stored data on the patient, the data filter for determining an accessibility of an information field to the user; and
directing a display to the user of a user-accessible information field.

12. The method recited in claim 11, further comprising the steps, following the verifying step of, if the user has a valid certification and the relationship between the user and the patient has been established in the database:
receiving a request from the user to amend an information field;
accessing in the database a data filter to be applied to stored data on the patient, the data filter for determining an amendability of an information field by the user; and
receiving from the user and entering into the database an amendment to a user-amendable information field.

13. A method for increasing patient compliance in disease or disorder self-management and for thereby decreasing healthcare costs for treating the patient for the disease or disorder, the method comprising the steps of:
establishing electronic communication between a patient having a disease or disorder and a healthcare management system, the healthcare management system comprising a database accessible by the processor, the database containing an electronic personal health journal, the journal comprising a plurality of fields of information relating to a patient, including health status and a self-care regimen;
offering to the patient an incentive for compliance with the self-care regimen;
establishing a reminder system for time and type of actions to be taken by the patient to comply with the self-care regimen;
issuing reminders commensurate with the established reminder system;
securely electronically communicating with the patient;
receiving from the patient and entering into the database data comprising an indication of timely completion of the actions; and
if the patient is determined to have been sufficiently compliant with the regimen, providing the offered incentive to the patient.

14. The method recited in claim 13, wherein the reminder issuing step comprises at least one of issuing a processor-mediated communication and issuing a reminder to a designated care giver, the care giver responsible for communicating with the patient personally.

15. The method recited in claim 13, wherein the communicating step comprises the steps of:
receiving a request from the patient to electronically access the database;
requesting the patient to provide an electronic, secure identification; and
verifying an identity of the patient.

16. A method for reducing duplication of services at a healthcare facility comprising the steps of:
receiving at a healthcare facility a request from a patient for treatment for an ailment;
receiving permission from the patient for secure access to at least a portion of an electronic healthcare record, the portion including data on prior patient treatment for the ailment;
electronically entering a secure healthcare management system comprising a database having therein health data on the patient;
providing electronic certification to the system of a registry of the facility with the system and of the received permission;
accessing the permitted portion of the record; and
if the ailment and the permitted portion of the record meet predetermined criteria, treating the patient for the ailment.

17. The method recited in claim 16, wherein the permitted portion of the record indicates a prior treatment of the patient for the same ailment at a second healthcare facility within a time period predetermined to be insufficient for a second treatment, and further comprising the step of denying treatment to the patient for the ailment.

18. The method recited in claim 17, wherein the requested treatment comprises a request for a controlled pharmaceutical.

19. A method for decreasing a likelihood of an adverse drug interaction in a patient comprising the steps of:
receiving at a healthcare facility a request from a patient for treatment for an ailment;
identifying a potential pharmaceutical with which to treat the ailment;
receiving permission from the patient for secure access to a portion of an electronic healthcare record including patient prescription data;
electronically entering a secure healthcare management system comprising a database having therein prescription data on the patient;
providing electronic certification to the system of a registry of the facility with the system and of the received permission; and
if the identified pharmaceutical and the patient prescription data meet predetermined criteria, prescribing the identified pharmaceutical to the patient.

20. The method recited in claim 19, further comprising the steps, following the electronic certification providing step, of accessing the patient prescription data and making a determination at the healthcare facility of an advisability of prescribing the identified pharmaceutical.

21. The method recited in claim 19, wherein the predetermined criteria comprise a determination of a potential for an adverse interaction between the identified pharmaceutical and any currently prescribed pharmaceutical in the patient prescription data.

22. The method recited in claim 19, wherein the healthcare management system includes software for making a determination of a potential for an adverse interaction between the identified pharmaceutical and any currently prescribed pharmaceutical in the patient prescription data.

23. A method for establishing a system for accessing and amending patient healthcare data, reducing duplication of healthcare services, increasing patient compliance in disease self-management, and decreasing a likelihood of an adverse drug interaction in a patient, the method comprising the steps of:
certifying and registering a plurality of users for healthcare information access;
establishing a secure database of healthcare information, the database comprising a plurality of individual electronic health journals, each journal comprising a plurality of fields of information relating a patient, including health status, the database further comprising data on each certified user including a user role;
establishing a community foundation for mediating healthcare management;
establishing a role-based rule set for granting access to and for permitting emendation of selected information fields in a journal by each user;
establishing a secure electronic protocol for granting access to each user with an electronic identification device;
receiving funding support for the foundation;
selecting community volunteers for providing motivational support to a patient for self-management of a patient disease.
